(19) United States
(12) Patent Application Publication
(10) Pub. No.: US 2012/0029824 A1
(43) Pub. Date: Feb. 2, 2012

(54) SYSTEM AND METHOD FOR IDENTIFYING REGIONS OF DISTINCT WIND FLOW

(75) Inventor: Megan M. Wilson, Greenville, SC (US)

(73) Assignee: GENERAL ELECTRIC COMPANY, Schenectady, NY (US)

(21) Appl. No.: 13/189,947

(22) Filed: Jul. 25, 2011

(51) Int. Cl. G01W 1/10; G06F 19/00

(52) U.S. Cl. 702/3

(57) ABSTRACT

Systems and methods for detecting areas of distinct wind flow in a region of a wind farm are disclosed. Areas of distinct flow can be identified by a computing tool based at least in part on wind velocity field data. For instance, using wind velocity field data, a finite-time Lyapunov exponent (FTLE) field, which measures the rate at which particles are stretching over time relative to each other, can be calculated. The FTLE field can be analyzed to determine the transport barriers in the flow. The maximum transport barriers of the FTLE field describe Lagrangian coherent structures (LCS). The LCS can be used to identify areas of distinct wind flow, which can be used to determine desirable locations for placement of wind measurement data or to identify recirculation zones.

### FIELD OF THE INVENTION

The present disclosure is generally directed to a method for determining regions of distinct wind flow, and more particularly to a method for determining desirable locations for wind measurement devices and wind turbines within a proposed wind farm site.

### BACKGROUND OF THE INVENTION

Wind turbines have received increased attention as environmentally safe and relatively inexpensive alternative energy sources. With this growing interest, considerable efforts have been made to develop wind turbines and wind turbine plants that are reliable, efficient, and cost-effective.

Placement of wind turbines within a wind power plant has traditionally been performed with the objective of increasing energy production. For example, in designing a wind farm, wind turbines are initially placed at locations within the geographic boundaries of the plant having the most suitable winds based on a wind resource grid.

A wind resource grid can be generated using a computing device having commercially available wind resource assessment or modeling software such as WindPro™ (available from EMD International A/S, Aalborg, Denmark) WindFarmer™ (available from Garrad Hassan, Bristol United Kingdom), or WindFarm™ (available from ReSoft Ltd., Banbury, United Kingdom). The wind resource grid can be generated based at least in part on wind velocity data collected and measured at the wind power plant site using a plurality of wind measurement devices. Other design criteria or constraints, such as exclusion zones, minimum spacing constraints, noise restrictions, and the like, are then used to adjust the turbine layout.

Other wind farm design objectives, such as reducing the cost of the wind farm, increasing financial metrics, and reducing noise may be taken into account in designing the plant layout. Computing devices executing various commercial software programs can be useful in this regard. For example, to address financial metrics and noise constraints, software such as WindPro™, WindFarmer™, or WindFarm™ offer analysis modules that can be used to assist with manual adjustment of the turbine layout as desired. Exclusion zones may also be considered in these programs.

Not all locations within the geographic boundaries of a proposed wind farm are suitable for placement of a wind turbine. Exclusion zones can be defined to specify areas that are not suitable or desirable for location of a wind turbine for any reason. For instance, an exclusion zone can be an area that includes a lake, unstable soil, inhospitable terrain, protected land region, or other area that is not suitable or desirable for location of a wind turbine.

Due to the complex terrain of many potential wind turbine plant locations, areas with distinct wind flow may exist in the wind velocity field associated with the region. For instance, FIG. 3 depicts wind 10 flowing over a large obstacle 20. As wind 10 flows over large obstacle 20, a portion of the wind 10 continues in generally the same direction as illustrated by streamline 15. However, as the wind 10 passes over obstacle 20, the direction of the wind flow may separate from the general direction of streamline 15, forming regions of distinct wind flow. For instance, recirculation zone 30 has formed adjacent obstacle 20. The wind flow within the boundaries of a region of distinct flow, such as recirculation zone 30, can experience significantly different wind speeds and turbulence than the surrounding area.

It is desirable to detect regions of distinct wind flow at a potential wind turbine plant location to assist in the measurement and development of wind velocity data and to identify recirculation zones. For instance, during the development of wind velocity data for a proposed wind farm site, it can be desirable to know the locations of areas of distinct wind flow to identify the areas for placement of wind measurement devices. This can also be used when there is poor cross-prediction between meteorological measurement devices to group turbines with the appropriate meteorological measurement devices based on these distinct regions. In addition, once a wind velocity field has been determined, for instance, using computational fluid dynamics and data collected by the wind measurement devices, it can be desirable to identify recirculation zones within the wind velocity field.

Wind turbines placed within a recirculation zone can be subject to greater wear and tear due to the varying wind velocities and turbulence in the recirculation zone. Thus, avoiding these regions is desirable when determining possible locations for wind turbines.

Boundaries of regions of distinct wind flow, such as recirculation zones, are not necessarily apparent from simply looking at wind velocity field data. Experts are typically required to examine the flow fields and manually identify regions that could potentially be recirculation zones. This typically involves a degree of guessing which can result in inconsistent results.

Thus, a need exists for a system and method that can be used to automatically detect regions of distinct flow in a wind velocity field. A system and method that identifies regions of distinct flow to assist in placement of wind measurement devices for developing wind velocity data would be useful. A system and method that identifies recirculation zones and defines the recirculation zones as exclusion zones in a wind turbine layout optimization tool, such as a computing device executing a wind turbine layout software application or similar wind turbine layout optimization tool, would be particularly useful.

### BRIEF DESCRIPTION OF THE INVENTION

Aspects and advantages of the invention will be set forth in part in the following description, or may be obvious from the description, or may be learned through practice of the invention.

One exemplary embodiment of the present disclosure is directed to a method for determining areas of distinct wind flow for a proposed wind power plant site. The method includes obtaining wind velocity field data for a region in the proposed wind power plant site; identifying with a computing device an area of distinct wind flow based at least in part on the wind velocity field data; and, mapping the area of distinct wind flow in the region.

Another exemplary embodiment of the present disclosure is directed to a system for determining areas of distinct wind flow for a proposed wind power plant site. The system includes at least one processing device and at least one memory. The memory includes computer-readable instructions for execution by the at least one processing device to control the at least one processing device to: obtain wind velocity field data for a region in the proposed wind power plant site; identify an area of distinct wind flow based at least in part on the wind velocity field data; and map the area of distinct wind flow in the region.

A further exemplary embodiment of the present disclosure is directed to a method for locating recirculation zones. The method includes obtaining wind field velocity data for a region; identifying with a computing device a recirculation zone from the wind field velocity data using a fluid dynamic computational algorithm; and mapping the recirculation zone in the region.

Variations and modifications can be made to these exemplary embodiments of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a wind power plant according to aspects of the present disclosure;

FIG. 2 is a plan view of a wind power plant plan for a site deemed suitable for wind turbines according to aspects of the present disclosure;

FIG. 3 is a diagram illustrating wind flowing over a large obstacle;

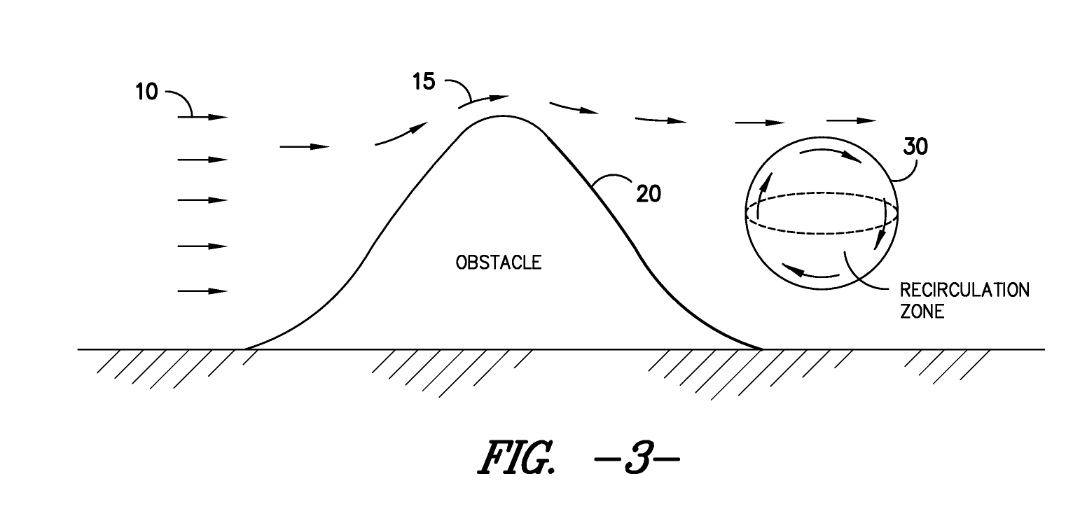

FIGS. 4 to 6 provide flow diagrams of exemplary methods according to exemplary embodiments of the present disclosure;

FIG. 7 depicts an exemplary wind velocity field according to aspects of the present disclosure;

FIG. 8 depicts an exemplary FTLE field for the wind velocity field of FIG. 7 in which the bold lines represent LCS;

FIG. 9 depicts an exemplary exclusion zone defined from analysis of the FTLE field of FIG. 8 according to an exemplary embodiment of the present disclosure; and,

FIG. 10 depicts a block diagram of an exemplary system for determining areas of distinct wind flow according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for automatically identifying areas of distinct wind flow from wind velocity field data. The areas of distinct wind flow can be automatically identified using a fluid dynamic computational algorithm. The identified regions of distinct flow can be used to determine locations for placement of wind measurement devices to be used in the generation of a wind velocity field for a proposed wind farm site. In particular applications, the regions of distinct flow can be used to identify recirculation zones in a region of a proposed wind farm site. The recirculation zones can be defined as exclusion zones that can be loaded into a wind turbine layout optimization tool, such as a computing device executing a software program configured to optimize wind turbine layouts or other suitable tool.

In a particular embodiment of the present disclosure, the time dependent computational fluid dynamic algorithm calculates a finite-time Lyapunov exponent (FTLE) field, which measures the rate at which particles are stretching over time relative to each other, from the wind velocity field data. The FTLE field can be calculated, for instance, by converting grid based velocity field data into a numerical particle representation that is analyzed over time. The FTLE field can be analyzed to determine contours in the flow. The maximum contour levels of the FTLE describe Lagrangian Coherent Structures (LCS). The LCS can be used to identify areas of distinct wind flow and, in certain applications, to define boundaries of recirculation zones.

The present disclosure provides a tool for automatic detection of areas of distinct wind flow. Detecting these regions enables the development of improved wind turbine layouts. For instance, identifying areas of distinct wind flow assists in the development of wind velocity data by identifying regions for placement of wind measurement devices.

The present disclosure also provides for increased automation in determining the layout of wind turbines in a region of a proposed wind farm by reducing the guessing aspect of determining the location of recirculation zones. By defining the identified recirculation zones as exclusion zones, significant downtime and possible failure that would otherwise occur for wind turbines placed in recirculation zones can be avoided.

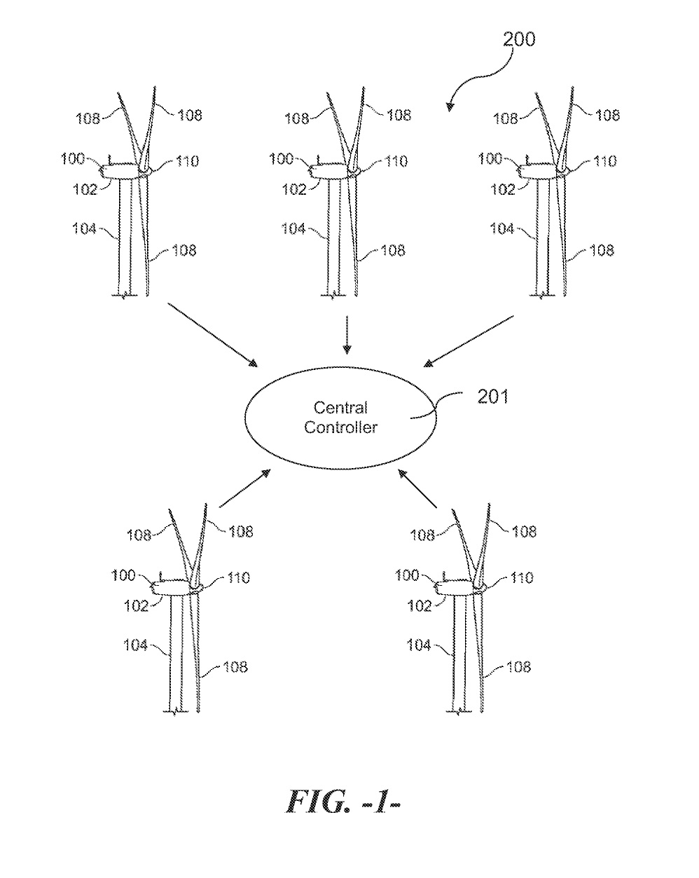

As shown in FIG. 1, a wind power plant 200 includes a number of wind turbines 100. Each turbine 100 generally comprises a nacelle 102 housing mounted atop a tower 104. The nacelle 102 generally includes a generator, controller, and other associated equipment. The height of the tower 104 is selected based upon various factors and may extend, for instance, to heights up to 60 meters or more. The wind turbines 100 may be installed on any terrain providing access to areas having desirable wind conditions. The terrain may vary greatly and may include, but is not limited to, mountainous terrain or off-shore locations. The wind turbines 100 also comprise a rotor 106 that includes one or more rotor blades 108 attached to a rotating hub 110.

The plurality of wind turbines 100 are preferably controlled and/or monitored from a central controller 201. Signals 203 may be transferred to and/or from the wind turbines 100 to provide monitoring data and/or control signals. The number of wind turbines 100 in the plant 200 is not a limiting factor, but is generally dictated by a combination of considerations. The wind power plant 200 is arranged to provide a combined power output.

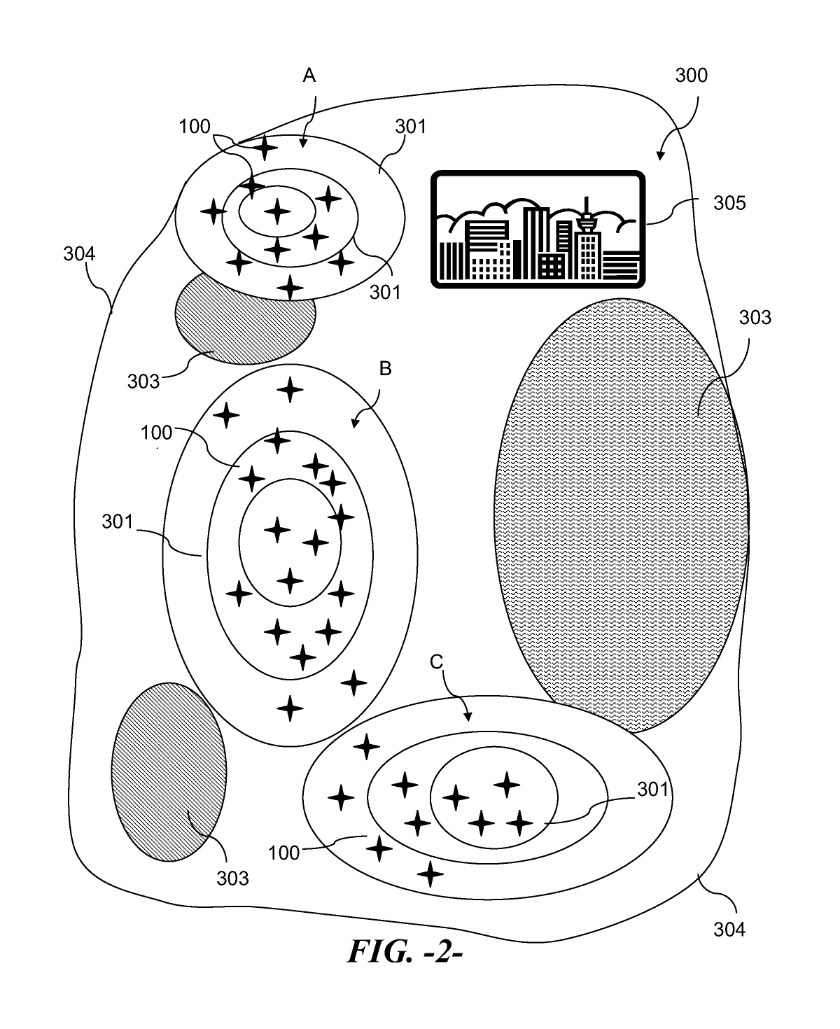

Referring to FIG. 2, a wind power plant is illustrated at a wind turbine site 300 bounded by boundary line 304. The site 300 includes a plurality of wind turbines 100 arranged therein. The site 300 includes one or more distinct regions, which are illustrated as regions A, B, and C in FIG. 2. The regions A-C may be defined by any combination of factors, but each region generally designates an area within the site 300 wherein a plurality of turbine locations are subjected to common wind conditions and constraints. Each of regions A-C includes a plurality of wind turbines 100 arranged on a variety of topography. The topography includes elevation contour lines 301 delineating changes in elevation within site 300 or a given region and can also include an accompanying surface roughness map. An important topography consideration is the presence of significant dwellings or industrial buildings, such as a nearby city or residential area 305.

The site 300 may include any manner of exclusion zone 303, which may be a lake, unstable soil, inhospitable terrain, protected land region, or other area on which a wind turbine cannot be located for any reason. Further, the site 300 may include or be in close proximity to noise sensitive areas, such as the area 305, which may include homes, businesses, natural reserves, or other areas that are sensitive or intolerant to noise or close proximity to wind turbines 100. It should be appreciated that the exclusion zones 303, including noise sensitive areas 305, can include any area that is sensitive or intolerant to the presence of wind turbine 100s, the wind turbine structure (e.g., tower 104), or the associated structures or support components of a wind power plant (e.g., access roads or protective fences, migratory bird paths, habitat area reduction concerns for various animals, etc.), noise generated from a wind power plant, or any other factor related to the presence of a wind power plant.

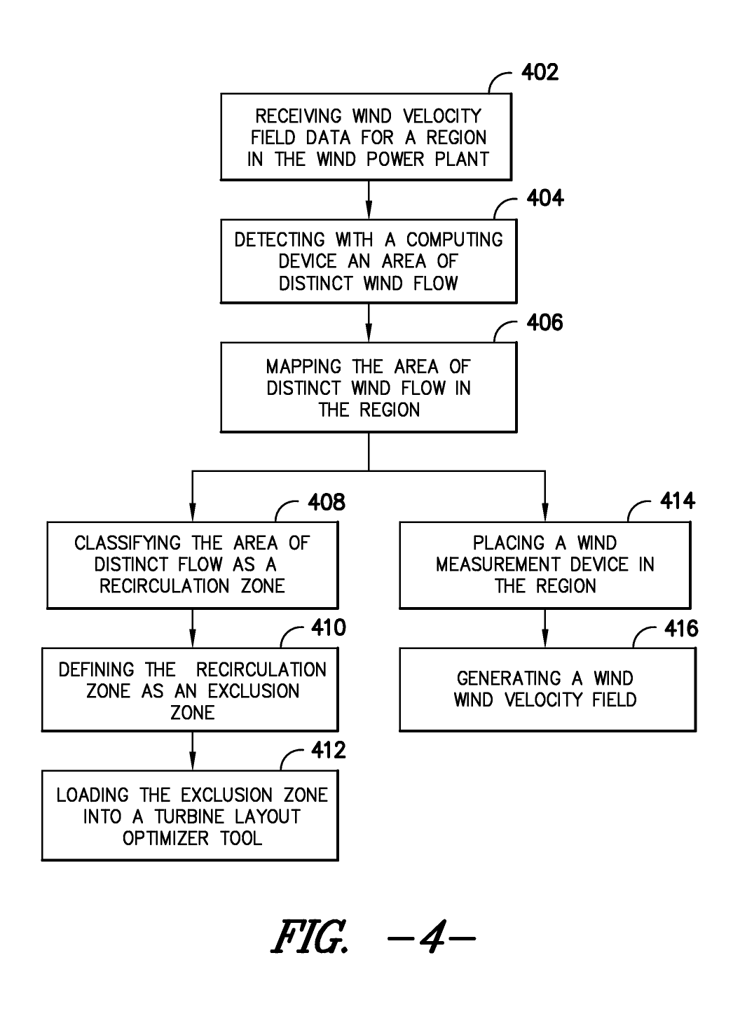

In accordance with exemplary aspects of the present disclosure, a method 400 is provided for determining a wind turbine layout at a wind power plant site 300. Referring to the flow diagram of FIG. 4, the method 400 includes at 402 receiving wind velocity field data for a region in the wind power plant site. The wind velocity field data can be any data or other information concerning wind flow for a particular region. For instance, the wind velocity field data can be a preliminary analysis or dummy wind field data associated with wind flow for a region. In another embodiment, the wind velocity field data can include a wind velocity field determined using conventional computational fluid dynamic techniques known in the art, including the use of commercially available software programs (such as WindSim™ and/or Meteodyn™), mesoscale modeling data, historical meteorological data, and any other type of tool or information available for developing an accurate wind resource assessment of the site. The wind velocity field can be developed using information or data collected by wind measurement devices placed within a proposed site for a wind farm. It should also be appreciated that any number of factors can be considered in determining the wind velocity field for a given region. For instance, factors, such as wind speed and direction, wind shear, air density, air temperature, pressure, and extreme wind probability can be considered in determining the wind velocity field for a region.

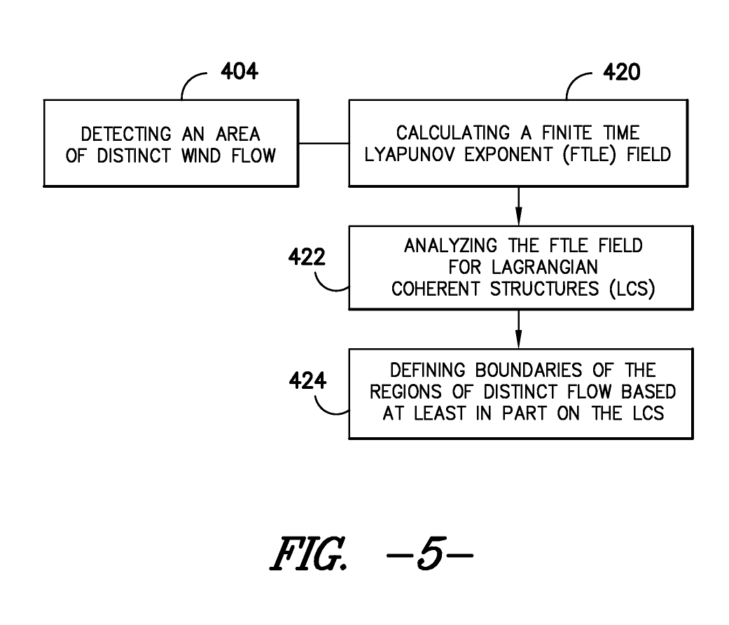

FIG. 7 illustrates a graphical depiction of an exemplary wind velocity field 820 for a region in a wind power plant site that includes a large obstacle 810. As illustrated, as wind 800 flows over large obstacle 810, an area of distinct wind flow 830 is formed in the wind velocity field 820. Although area 830 is readily apparent from examination of wind velocity field 820, not all areas of distinct wind flow can be easily discerned from simple examination of the wind velocity field 820. Moreover, due to the transient nature of wind flow, manifolds separating areas of distinct flow can be changing, leading to difficult detection of areas of distinct wind flow from the wind velocity field data.

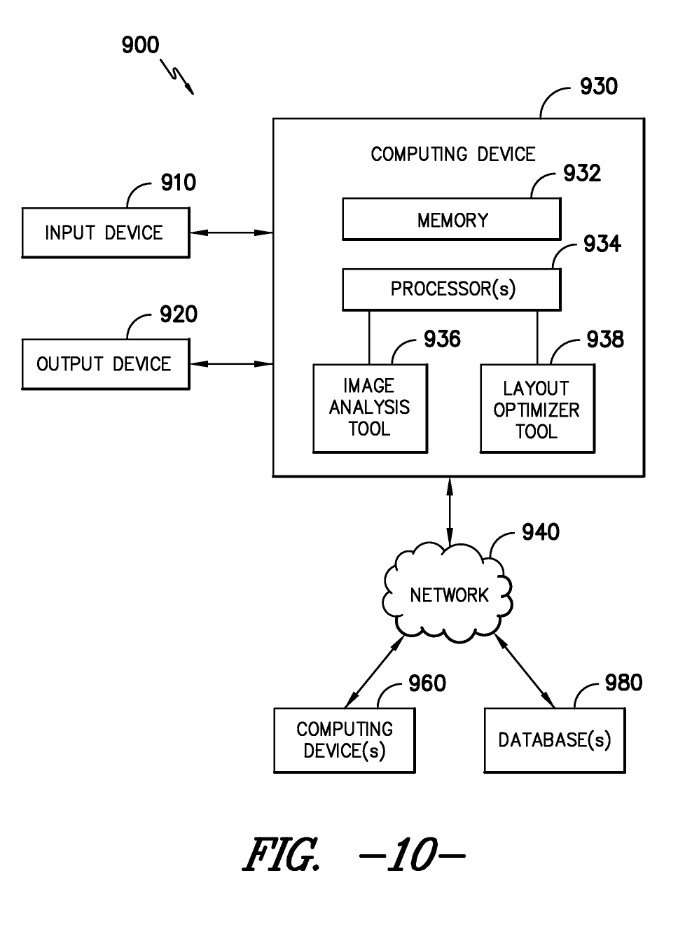

After receiving the wind velocity field data, the method 400 includes at 404 detecting an area of distinct wind flow with a computing device. The use of a computing device to detect areas of distinct wind flow eliminates guesswork and provides more automation to the process of developing intelligent wind layouts for wind farm sites. An exemplary computing system 900 that can be used to automatically detect areas of distinct wind flow will be discussed in detail below with reference to FIG. 10.

Referring still to FIG. 4, the method 400 at 406 includes mapping the area of distinct wind flow in the region. In this manner, the method 400 provides for a way of determining areas of distinct wind flow in a region for a proposed wind farm site. As discussed in more detail below, this information can be used to determine placement of wind measurement devices used to collect wind data or to identify recirculation zones in the wind velocity field.

In a particular embodiment, the method 400 can include at 414 placing a wind measurement device in the region based at least in part on the determined areas of distinct wind flow. For instance, if the method 400 detects two distinct areas of distinct wind flow, a wind measurement device can be placed in each distinct area of distinct wind flow. In this manner, the method 400 provides a way for more accurate collection of wind data for a region in a proposed wind farm site by ensuring collection of wind measurement data for each region of distinct wind flow. A wind velocity field can be generated using computational fluid dynamics and data collected by the wind measurement devices as indicated at 416.

In another embodiment, the method 400 can be used to detect recirculation zones from the wind velocity field data. For instance, as shown at 408, the method 400 can include classifying the area of distinct flow as a recirculation zone. The method 400 can then define the recirculation zone as an exclusion zone for the wind turbine layout plan as shown at 410. As discussed above, an exclusion zone specifies an area where location of a wind turbine is not desirable. By defining recirculation zones as exclusion zones in a wind turbine layout plan, placement of a wind turbine in a recirculation can be more readily avoided. At 412, the method can include loading the newly defined exclusion zones into a turbine layout optimization tool. A turbine layout plan can then optimized that automatically avoids the placement of wind turbines in the detected recirculation zones.

Referring now to FIG. 5, an exemplary method for detecting one or more areas of distinct flow with a computing device 404 will be discussed in detail. At 420, a finite time Lyapunov exponent (FTLE) field is calculated with the computing device from the wind velocity field data. A FTLE is a scalar value which characterizes the amount of stretching about a point over a given time interval. The FTLE field can be calculated, for instance, by converting grid based velocity field data into a numerical particle representation that is analyzed over time. In particular, the FTLE calculation can measure an integrated separation between particle trajectories in the wind velocity field. By analyzing the separation about a point in the wind velocity field, dynamically distinct regions in the wind velocity field can be identified. The FTLE values for different points in the region can be plotted as a FTLE field for the region.

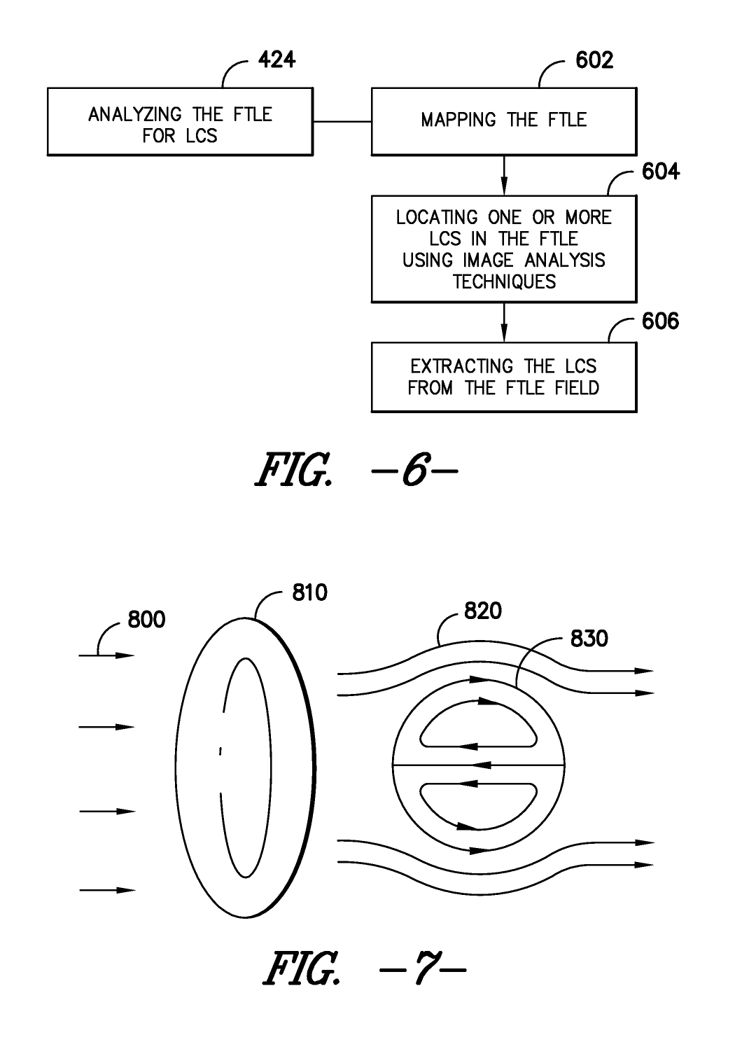

FIG. 8 provides a graphical depiction of an exemplary FTLE field 840 for the wind velocity field depicted in FIG. 7. The varying cross-hatched portions represent portions of the FTLE field 840 with similar FTLE values. As shown, the FTLE field 840 includes various contours or transport barriers 842, 844, and 850. Contour 850 represents a maximum transport barrier (transport barrier with the highest FTLE values) or Lagrangian Coherent Structure (LCS) for the FTLE field 840. The LCS 850 can be used to identify areas of distinct wind flow. This is due to the relatively high amount of stretching about a point at the area proximate the boundary of distinct wind flow.

For instance, at 424 of FIG. 5, the FTLE field can be analyzed to determine the presence of one or more LCS. Once the LCS have been identified, boundaries of the areas of distinct wind flow can be identified based at least in part on the locations of LCS in the FTLE field as shown at 424 of FIG. 5. In this manner, a computing device can detect one or more regions of distinct flow in a wind velocity field by identifying LCS in a FTLE field.

FIG. 6 depicts a flow chart of a method for analyzing a FTLE field for LCS 424 according to an exemplary embodiments of the present disclosure. For instance, in one particular implementation, the method includes mapping the FTLE field as shown at 602. The FTLE field can mapped as a digital image or other suitable representation of the FTLE field. The digital image can include a plurality of pixels. The pixel value associated with each of the plurality of pixels can be based on the FTLE value for that particular point in the wind velocity field.

At 604, the method includes locating one or more LCS in the FTLE using image analysis techniques. The LCS can be regions in the mapped FTLE field that have a high pixel value relative to adjacent portions of the wind velocity field. For instance, in a particular embodiment, digital image analysis techniques can be performed to identify with high pixel values relative to adjacent regions. These regions can be identified as LCS, which in turn can be used define the boundaries of an area of distinct wind flow.

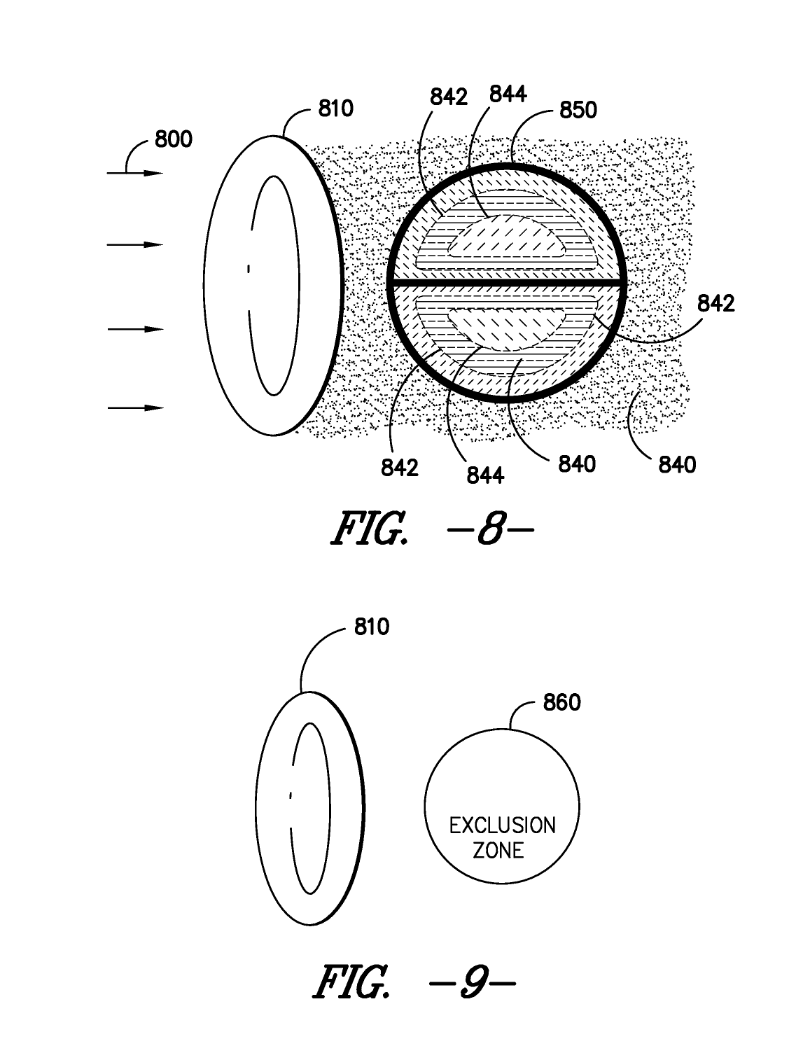

Once the LCS have been located, the LCS can then be extracted from the FTLE field as shown at 606. For instance, FIG. 8 depicts a graphical representation of a FTLE field 840 for the wind velocity field data shown in FIG. 7. Image analysis techniques can be performed on the representation of the FTLE field 840 to extract LCS 850. For instance, image analysis techniques can be performed to extract the high pixel values associated with LCS 850. LCS 850 can be used to define the boundaries of a, for instance, a recirculation zone. The recirculation zone is then defined as an exclusion zone 860 in a wind turbine layout plan as illustrated in FIG. 9.

FIG. 10 illustrates an exemplary computing system 900 that can be used to implement the exemplary methods of detecting areas of distinct wind flow, such as recirculation zones, according to exemplary embodiments of the present disclosure. The computer based system 900 can include one or more general-purpose or customized computing devices adapted in any suitable manner to provide desired functionality. Computer based system 900 may be adapted to provide additional functionality complementary or unrelated to the present subject matter as well.

As illustrated, computer based system 900 can include a computing device 930 having a memory 932 and a processor 934. Memory 932 can be provided as a single or multiple portions of one or more varieties of computer-readable media, such as but not limited to any combination of volatile memory (e.g., random access memory (RAM, such as DRAM, SRAM, etc.) and nonvolatile memory (e.g., ROM, flash, hard drives, magnetic tapes, CD-ROM, DVD-ROM, etc.) or any other memory devices including diskettes, drives, other magnetic-based storage media, optical storage media, solid state storage media and others.

Processor 934 can be a microprocessor or other suitable processing device configured to execute software instructions rendered in a computer-readable form stored in memory 932. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific circuits.

As illustrated computing device 930 can be coupled to input device(s) 910 and output device(s) 920. Exemplary input device(s) 910 can include but are not limited to a keyboard, touch-screen monitor, eye tracker, microphone, mouse and the like. Exemplary output device(s) 920 can include but are not limited to monitors, printers or other devices for visually depicting output data created in accordance with the disclosed technology.

Computing device 930 can be connected to other computing devices 960 and databases 980 over network 940. Network 940 can be comprise any number and/or combination of hard-wired, wireless, or other communication links. One of ordinary skill in the art will recognize that the inherent flexibility of computer-based systems allows for a great variety of possible configurations, combinations, and divisions of tasks and functionality between and among components. For instance, the processes discussed herein may be implemented using single computing device 930 or across multiple computing devices, such as computing device 930 and computing device(s) 960 and database(s) 980 working in combination.

Processor 934 can be configured to execute computer readable instructions to execute the methods for detecting areas of distinct wind flow in a wind velocity field discussed herein. For instance, the processor can execute computer readable instructions to calculate a FTLE field and analyze the FTLE for LCS to define boundaries of recirculation zones. In a particular implementation, the processor 934 can be coupled to an image analysis tool 936. The image analysis tool 936 can be configured to extract the maximum transport barriers from the FTLE field and provide a digital representation of the maximum transport barriers to a user through output device 920.

Computing device 930 may also include a turbine layout optimization tool 938, such as a computing device executing a software program configured to optimize wind turbine layouts or other suitable tool. The turbine layout optimization tool 938 can be used to determine a suitable layout for a region at a wind farm site. In addition, exclusion zones defined based on the location of recirculation zones in the wind velocity field can be loaded into the wind turbine layout plan to provide an improved wind turbine layout plan.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for determining areas of distinct wind flow for a proposed wind farm site, the method comprising:
obtaining wind velocity field data for a region in the proposed wind farm site;
identifying with a computing device an area of distinct wind flow based at least in part on the wind velocity field data; and, mapping the area of distinct wind flow in the region.

2. The method of claim 1, the method further comprising:
determining that the area of distinct flow is a recirculation zone;
defining the recirculation zone as an exclusion zone in a wind turbine layout plan, the exclusion zone specifying an area that is not desirable for placement of a wind turbine.

3. The method of claim 2, the method further comprising comprises loading the exclusion zone into a wind turbine layout optimization tool.

4. The method of claim 1, the method further comprising:
placing a wind measurement device in the region of the proposed wind farm site based at least in part on the mapped area of distinct wind flow; and
generating a wind velocity field based at least in part on data collected by the wind measurement device.

5. The method of claim 1, wherein detecting with the computing device an area of distinct wind flow comprises calculating a finite-time Lyapunov exponent (FTLE) field from the wind velocity field data.

6. The method of claim 5, wherein detecting with the computing device an area of distinct wind flow further comprises analyzing the FTLE field for one or more Lagrangian coherent structures (LCS).

7. The method of claim 6, the method further comprising defining a boundary of a recirculation zone based at least in part on the one or more LCS.

8. The method of claim 7, wherein analyzing the FTLE field comprises:
mapping the FTLE field;
locating one or more LCS in the FTLE field using image analysis techniques; and,
extracting the one or more LCS from the FTLE field.

9. The method of claim 7, the method further comprising generating a wind turbine layout plan based at least in part on the mapped area of distinct wind flow.

10. A system for determining areas of distinct wind flow for a proposed wind power plant site, the system comprising:
at least one processing device; and,
at least one memory comprising computer-readable instructions for execution by said at least one processing device to control said at least one processing device to:
obtain wind velocity field data for a region in the proposed wind power plant site;
identify an area of distinct wind flow based at least in part on the wind velocity field data; and,
map the area of distinct wind flow in the region.

11. The system of claim 10, wherein said computer-readable instructions control said at least one processing device to:
determine that the area of distinct flow is a recirculation zone;
define the recirculation zone as an exclusion zone in the wind turbine layout plan, the exclusion zone specifying an area that is not desirable for placement of a wind turbine; and
load the exclusion zone into a wind turbine layout optimization tool.

12. The system of claim 10, wherein said computer-readable instructions control said at least one processing device to detect an area of distinct wind flow by calculating a finite-time Lyapunov exponent (FTLE) field from the wind velocity field data.

13. The system of claim 12, wherein said computer-readable instructions control said at least one processing device to detect one or more recirculation zones by analyzing the FTLE field for one or more Lagrangian Coherent Structures (LCS).

14. The system of claim 13, wherein said computer-readable instructions further control said at least one processing device to:
map the FTLE field;
locate one or more LCS in the FTLE field using image analysis techniques; and,
extract the LCS from the FTLE field.

15. A method for locating recirculation zones, the method comprising:
obtaining wind velocity field data for a region;
identifying with a computing device a recirculation zone from the wind field velocity using a fluid dynamic computational algorithm; and,
mapping the recirculation zone in the region.

16. The method of claim 15, wherein identifying with a computing device a recirculation zone from the wind field velocity data using a fluid dynamic computational algorithm comprises:
calculating a finite-time Lyapunov exponent (FTLE) field from the wind field velocity data;
analyzing the FTLE field for one or more Lagrangian coherent structures (LCS), and,
defining one or more recirculation zones based at least in part on the one or more LCS.

17. The method of claim 15, the method further comprising defining the recirculation zone as an exclusion zone in a wind turbine layout plan, the exclusion zone specifying an area that is not desirable for placement of a wind turbine.

18. The method of claim 15, the method further comprising loading the exclusion zone into a wind turbine layout optimization tool.

19. The method of claim 16, wherein analyzing the FTLE field for LCS comprises:
mapping the FTLE field;
locating one or more LCS in the Lyapunov exponent field using image analysis techniques; and,
extracting the LCS from the FTLE field.

20. The method of claim 15, the method further comprising generating a wind turbine layout plan based at least in part on the mapped area of distinct wind flow.
